(19) United States
(12) Patent Application Publication
(10) Pub. No.: US 2007/0008347 A1
(43) Pub. Date: Jan. 11, 2007

(54) Voltage generator for flat panel display

(75) Inventor: Dae-Sung Choi, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/485,541

(22) Filed: Jul. 11, 2006

(30) Foreign Application Priority Data
Jul. 11, 2005 (KR) 2005-62312

(51) Int. Cl. G09G 5/10; G09G 5/00

(52) U.S. Cl. 345/690; 345/208; 345/211

(57) ABSTRACT

A voltage generator for a flat panel display includes a bandgap reference voltage generator configured to generate a reference voltage responsive to a received power voltage, and a gray scale voltage generator configured to receive the reference voltage from the bandgap reference voltage generator and to generate a gray scale voltage responsive to the reference voltage. Because the bandgap reference voltage generator is not influenced by external voltage fluctuations or by variations in temperature, a stable reference voltage can be generated, and a stable gray scale voltage can be obtained.

### BACKGROUND OF THE INVENTION

1. Field of the Invention

The present invention relates to a display, and more particularly, to a voltage generator circuit for a flat panel display.

2. Description of the Related Art

A visual display on an electronic device is a popular, and often necessary, user interface. Lightweight flat panel displays, having slim profiles, are widely used with miniaturized electronic devices. In addition to being useful for applications involving portable and miniaturized electronic devices, the space-saving, lightweight, and power-sparing features of flat displays make them quite suitable for use as a larger user interface including, for example, a computer display or a television display unit. In general, flat displays can be classified according to the type of image display panels employed, including organic light emitting diode displays (OLEDs), liquid crystal displays (LCDs), field emission displays (EFDs), vacuum fluorescent displays (VFDs), and plasma display panels (PDPs).

While the driving voltages and the gray scale voltages can be supplied by a separate external power supply source, the electronic device having the flat panel display, such as a handheld terminal, typically generates the driving voltages and the gray scale voltages using an external power voltage inputted through a single solder bump connection. For stable image quality, it is desirable to supply stable gray scale voltages (VGM). However, when power consumption provided by the driving voltage increases during LCD operation, an undesirable ripple may be generated in the reference voltage (VREF) used to generate gray scale voltage VGM. This ripple tends to result gray scale voltage fluctuations, causing a deterioration in LCD image quality.

### SUMMARY OF THE INVENTION

A voltage generator is provided that can generate a generally stable gray scale voltage for a flat panel display. A display that can generate a stable gray scale voltage also is provided. Selected embodiments herein provide a voltage generator for a flat panel display that includes a bandgap reference voltage generator. The bandgap reference voltage generator is configured to generate a reference voltage responsive to a received power voltage, for example, from a power voltage external to the voltage generator. In turn, the gray scale voltage generator is configured to receive the reference voltage from the bandgap reference voltage generator and configured to generate a gray scale voltage responsive to the reference voltage. In some embodiments, the gray scale generator can include an amplifier having a first input terminal, a second input terminal, and an output terminal. At least two resistances can be connected in series between the output terminal of the amplifier and a ground voltage, with a connection node being disposed between the at least two resistances. The first input terminal can receive the reference voltage, the second input terminal can be connected with the connection node between the resistances, and the amplifier can generate the gray scale voltage on the output terminal. The resistances can be selectably variable resistances.

Other embodiments can provide a flat panel display including a bandgap reference voltage generator and a gray scale voltage generator. The bandgap reference voltage generator can be configured to generate a reference voltage responsive to a received power voltage, for example, from a power voltage external to the voltage generator, and the gray scale voltage generator can be configured to receive the reference voltage from the bandgap reference voltage generator, and configured to generate a gray scale voltage responsive to the reference voltage.

### BRIEF DESCRIPTION OF THE DRAWINGS

The accompanying drawings, which are included to provide a further understanding of the invention and are incorporated in and constitute a part of this application, illustrate embodiment(s) of the invention, and together with the description serve to explain the principle of the invention. In the drawings:

FIG. 1 is a block diagram showing a block diagram of an LCD-type flat panel display;

FIG. 2 is a circuit diagram illustrating an exemplary conventional voltage generator; and

FIG. 3 is a circuit diagram illustrating a voltage generator according to an inventive embodiment herein.

### DETAILED DESCRIPTION OF THE INVENTION

Reference will now be made in detail to the preferred embodiments of the present invention, examples of which are illustrated in the accompanying drawings. However, the embodiments herein are illustrative and not to be construed to be limiting, and are introduced to facilitate understanding of the scope and spirit of the present invention.

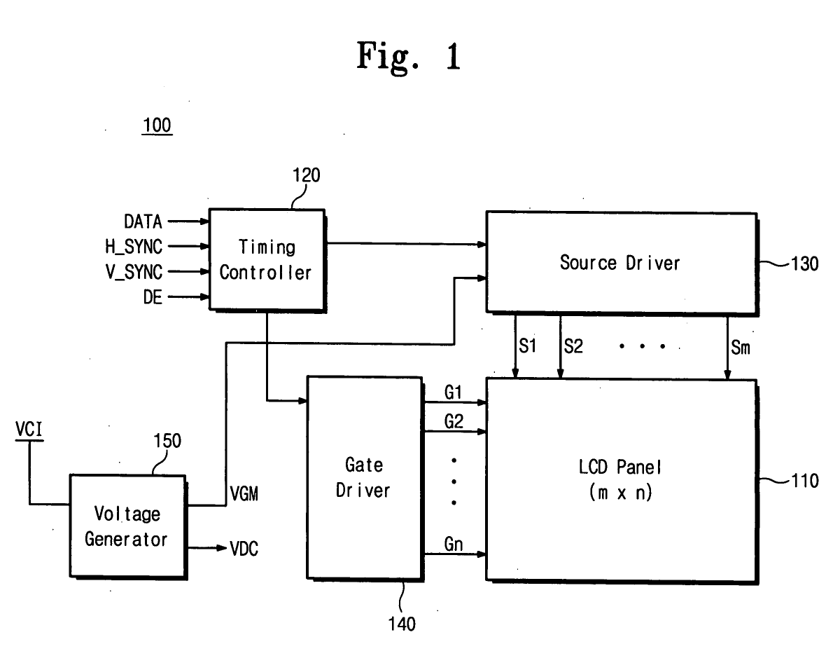

FIG. 1 is a block diagram illustrating a flat panel display construction, for example, an LCD. Referring to FIG. 1, the LCD 100 includes a liquid crystal panel 110, a timing controller 120, a source driver 130, a gate driver 140, and a voltage generator 150. The liquid crystal panel 110 includes a plurality of gate lines, a plurality of data lines perpendicularly intersecting the plurality of gate lines, and a plurality of pixels defined by intersection of the gate lines and the data lines. Typically, the plurality of pixels are arranged in a matrix configuration. Each pixel includes a thin film transistor whose gate electrode and source electrode are respectively connected with the gate line and the data line, a liquid crystal capacitor (not shown) connected with drain electrode of the thin film transistor, and a storage capacitor (not shown). In such a pixel structure, the plurality of gate lines are sequentially selected by a gate driver 140. When a gate ON voltage is applied in a pulse format to a selected one of the gate lines, the thin film transistor of a pixel connected to the selected gate line is turned ON, and then a voltage including pixel information is applied to each data line by the source driver 130. The voltage is applied to the liquid crystal capacitor and the storage capacitor via the thin film transistor of the corresponding pixel to drive the liquid crystal capacitor, so that an image is displayed.

The timing controller 120 receives a horizontal synchronous signal (H_SYNC), a vertical synchronous signal (V_SYNC), a data enable signal (DE), and an RGB data signal (DATA) all of which are inputted from an external graphic source. The timing controller 120 converts input data into output data having formats suitable to those specified for the liquid crystal panel 110. Controller 120 outputs RGB data signals (IDATA) and control signals, such as the horizontal synchronous signal and load signal, to the source driver 130. The source driver 130 generally includes a plurality of source driver ICs, and generates signals for driving the source lines (S1-Sm) of the liquid crystal panel 110, in response to the RGB data and the control signals that are provided from the timing controller 120. Also, the timing controller 120 outputs control signals, such as vertical synchronous start signal, gate clock signal, and output enable signal, in response to the horizontal synchronous signal (H_SYNC), vertical synchronous signal (V_SYNC) and data enable signal (DE).

The gate driver 140 includes a plurality of gate driver ICs, and sequentially scans the gate lines (G1-Gn) of the liquid crystal panel 110 according to the control signals provided from the timing controller 120. Herein, the term scanning means the act of sequentially applying gate ON voltage to gate lines, such that pixels corresponding to the gate lines, to which the gate ON voltage is applied, can record data. The voltage generator 150 receives a power voltage provided from a source external to generator 150 to generate output voltages VCD and VGM, which may be used in the LCD 100.

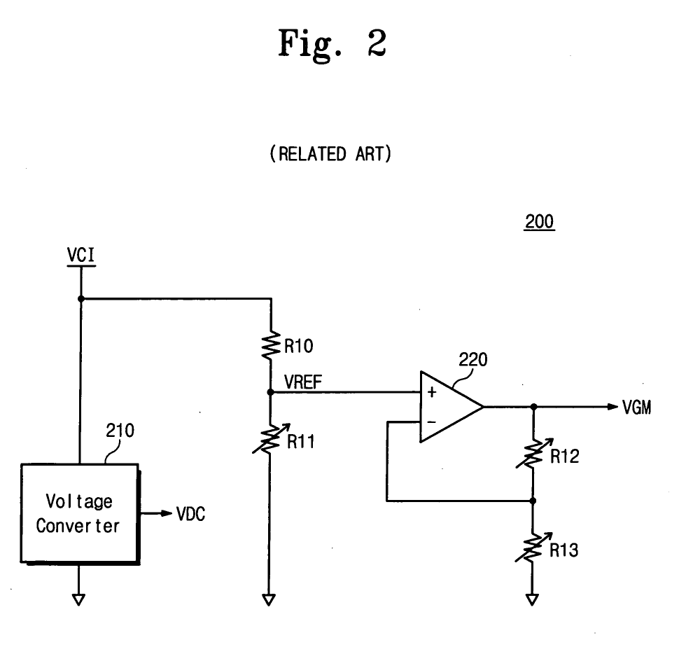

FIG. 2 is a circuit diagram showing one example of a conventional voltage generator 200. Referring to FIG. 2, the conventional voltage generator 200 includes a voltage converter 210, an operational amplifier 220, and resistances R10-R13. The voltage converter 210 converts the power voltage provided from a source external to generator 200, such as voltage VCI, into a driving voltage VDC. The driving voltage VDC can be, for example, a voltage used to drive the timing controller 120, the source driver 130, and the gate driver 140 inside the LCD 100 shown in FIG. 1. The resistances R10 and R11 can be connected in series between the external power voltage VCI and a ground voltage, and can have a first connection node disposed therebetween. The resistance R11 can be a variable resistance. Resistances R10 and R11 can form a voltage divider, with a reference voltage VREF being generated at the first connection node being supplied to the operational amplifier 220.

The operational amplifier 220 has a first input terminal (+), a second input terminal (−) and an output terminal. First input terminal (+) receives the voltage VREF generated on the first connection node. The resistances R12 and R13 are connected in series between the output terminal of the operational amplifier 220 and the ground voltage. A second connection node between the resistances R12 and R13 can be connected with the second input terminal (−) of the operational amplifier 220. The resistances R12 and R13 can be selectably variable resistances, respectively. Hence, the operational amplifier 220 can output a gray scale voltage VGM corresponding to the resistance values of the variable resistances R12 and R13. In general, the voltages used by the LCD 100 can be one of driving voltages and gray scale voltages. Driving voltages can be used to drive the timing controller 120, the source driver 130, and the gate driver. The gray scale voltages can be used by the source driver to drive the source lines S1-Sm.

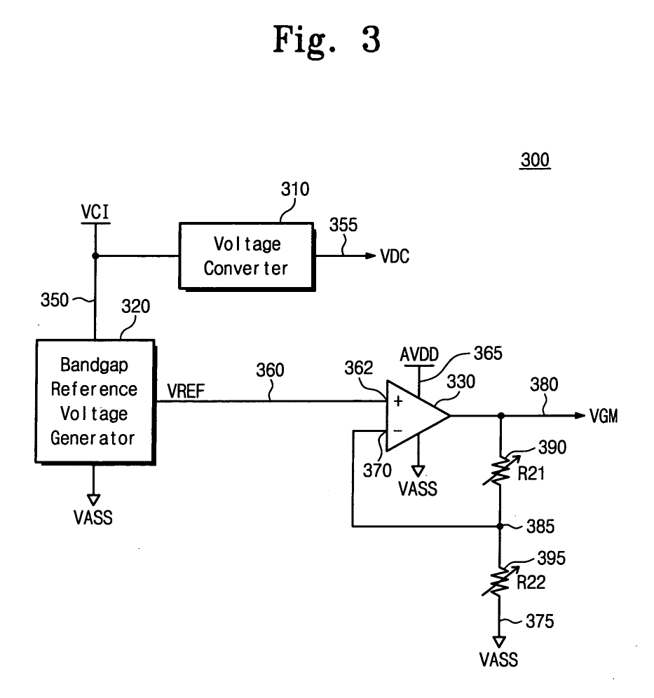

FIG. 3 is a circuit diagram showing a voltage generator 300 according to a preferred embodiment of the present invention. Referring to FIG. 3, the voltage generator 300 can include a voltage converter 310, a bandgap reference voltage generator 320, an operational amplifier 330, and resistances R21 (390) and R22 (395). The voltage converter 310 can convert a power voltage provided from a power voltage source external to generator 300 into a driving voltage VDC 355. The external power voltage can include, for example, power voltage VCI 350. When voltage generator 300 is provided in place of voltage generator 150 shown in FIG. 1, for example, the driving voltage VDC can drive the timing controller 120, the source driver 130, and the gate driver 140 inside the LCD 100. In general, the bandgap reference voltage generator 320 can be configured to receive a power voltage external to generator 300, for example, external power voltage VCI 350, to generate a stable reference voltage VREF 360. The bandgap reference voltage generator 320 may generate precise voltages in a manner that can be substantially independent of changes in factors external to generator 300, including, without limitation, the external power voltage VCI 350 and the temperature ambient to generator 300.

Desirably, the reference voltage VREF 360 generated by the bandgap reference voltage generator 320 can be, for example, about 1.44V. A suitable bandgap reference voltage can be generated by known plural devices and related methods, including without limitation, a method of generating a bandgap voltage using a CMOS lateral bipolar transistor; a method of generating a bandgap voltage using a difference in threshold voltage between an enhancement MOS transistor and a depletion MOS transistor; and a method of generating a bandgap voltage using only an enhancement MOS transistor. Typically, the operational amplifier 330 has a first input terminal (+) 362, a second input terminal (−) 370, and an output terminal 380. Desirably, the first input terminal (+) 362 is configured to receive the reference voltage VREF 360 from the bandgap reference voltage generator 310. Typically, the resistances R21 (390) and R22 (395) are connected in series between the output terminal (380) of the operational amplifier 330 and a ground voltage (375), e.g., VASS. A connection node 385 can be disposed between the resistances R21 (390) and R22 (395), and can be electrically connected with the second input terminal (−) 370 of the operational amplifier 330. Desirably, the resistances R21 (390) and R22 (395) can be selectably variable resistances, respectively. Hence, the operational amplifier 330 can output on the output terminal 380 a gray scale voltage VGM, responsive to the reference voltage VREF 360 and corresponding to the selected resistance values of the selectably variable resistances R21 (390) and R22 (395), in accordance with known principles relating to circuits including therein an operational amplifier. The power voltage AVDD 365 of the operational amplifier 330 can be employed as a bias voltage of the gray scale voltage. Advantageously, because the bandgap reference voltage generator 320 outputs a generally stable reference voltage VREF 360, it is possible for the gray scale voltage to also be generated in a generally stable state. Moreover, the gray scale voltage VGM can be maintained in a generally stable state regardless of factors which may vary during LCD operation, including without limitation, the amount of the driving current and the external power voltage VCI 350. For a stable image display, it is desirable that the gray scale voltage be kept in a stable state, as well as a common electrode voltage VCOM (not shown). Common electrode voltage VCOM may be supplied to an end of liquid crystal capacitors inside the liquid crystal panel. Hence, to generate a generally stable common voltage, it also may be advantageous to construct a common electrode voltage generator (not shown) using the reference voltage VREF 360 generated by the bandgap reference voltage generator 320.

As described above, according to the present invention, the power generator for a flat panel display can generate a gray scale voltage that is generally stable substantially independently of changing environmental factors including without limitation, an external power voltage and the temperature ambient to the power generator. It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A voltage generator for a flat display, comprising:
a bandgap reference voltage generator configured to generate a reference voltage responsive to a received power voltage; and
a gray scale voltage generator configured to receive the reference voltage from the bandgap reference voltage generator and configured to generate a gray scale voltage responsive to the reference voltage.

2. The voltage generator of claim 1, wherein the gray scale generator comprises:
an amplifier having a first input terminal, a second input terminal, and an output terminal; and
at least two resistances connected in series between the output terminal of the amplifier and a ground voltage, and having a connection node therebetween,
wherein the first input terminal receives the reference voltage from the bandgap reference voltage generator,
wherein the second input terminal is connected to the connection node, and
wherein the output terminal outputs the gray scale voltage.

3. The voltage generator of claim 2, wherein the respective resistances comprise selectably variable resistances.

4. A display comprising:
a bandgap reference voltage generator configured to generate a reference voltage responsive to a received power voltage; and
a gray scale voltage generator configured to receive the reference voltage and configured to generate a gray scale voltage responsive to the reference voltage.

5. The display of claim 4, wherein the gray scale generator comprises:
an amplifier having a first input terminal, a second input terminal, and an output terminal; and
at least two resistances connected in series between the output terminal of the amplifier and a ground voltage, and having a connection node therebetween,
wherein the first input terminal receives the reference voltage from the bandgap reference voltage generator,
wherein the second input terminal is connected to the connection node, and
wherein the amplifier generates the gray scale voltage on the output terminal.

6. The display of claim 5, wherein the respective resistances comprise selectably variable resistances.

7. A voltage generator for a display, comprising:
a bandgap reference voltage generator configured to receive a power voltage from a power voltage supply external to the voltage generator and configured to generate a reference voltage corresponding to a semiconductor bandgap voltage responsive to the power voltage, and wherein the display is a flat panel display.

8. The voltage generator of claim 7, further comprising:
a gray scale voltage generator configured to receive the reference voltage from the bandgap reference voltage generator and configured to generate a gray scale voltage responsive to the reference voltage.

9. The voltage generator of claim 8, wherein the gray scale generator comprises:
an amplifier having a first input terminal, a second input terminal, and an output terminal; and
at least two resistances connected in series between the output terminal of the amplifier and a ground voltage,
wherein the first input terminal is configured to receive the reference voltage,
wherein a connection node is disposed between ones of at least two resistances connected in series, and is connected with the second input terminal of the amplifier; and
wherein the amplifier generates the gray scale voltage on the output terminal.

10. The voltage generator of claim 9, wherein each of the at least two resistances further comprises a selectably variable resistance.

11. A display, comprising:
a bandgap reference voltage generator configured to receive a power voltage from a power voltage supply external to the voltage generator and configured to generate a reference voltage corresponding to a semiconductor bandgap voltage responsive to the power voltage, and;
a gray scale voltage generator, comprising an amplifier having a first input terminal, a second input terminal, and an output terminal, and at least two resistances connected in series between the output terminal of the amplifier and a ground voltage,
wherein the first input terminal is connected to the bandgap reference voltage generator and configured to receive the reference voltage,
wherein a connection node is disposed between ones of at least two selectably variable resistances connected in series,
wherein the connection node is electrically connected with the second input terminal of the amplifier,
wherein the gray scale voltage generator is configured to receive the reference voltage from the bandgap reference voltage generator, and configured to generate on the output terminal a gray scale voltage responsive to the reference voltage, and
wherein the display is a flat panel display.
